(19) United States
(12) Patent Application Publication
(10) Pub. No.: US 2017/0105092 A1
(43) Pub. Date: Apr. 13, 2017

(54) Application and a method for two-way communication between participating smartphones, of each other's real-time geographic location information, during a phone call.

(71) Applicant: Jithendra Renati, Irving, TX (US)

(72) Inventor: Jithendra Renati, Irving, TX (US)

(21) Appl. No.: 15/235,284

(22) Filed: Aug. 12, 2016

Related U.S. Application Data
(60) Provisional application No. 62/239,868, filed on Oct. 10, 2015.

(51) Int. Cl. H04W 4/02; H04L 29/06; H04L 29/08

(52) U.S. Cl. CPC H04W 4/02; H04L 67/02; H04L 67/42

(57) ABSTRACT

An application, which when installed in any two smartphones, can obtain their respective real-time geographic locations through GPS enabled on the said devices, when a phone call is made through one of the said smartphones to the said other smartphone; send—through web service—the said location information to a central server, which resolves the said location information into a simpler user-friendly format—for example, street address—and conveys the resolved location information to the two smartphones such that the location of the calling device is provided to and displayed on the receiving device and vice versa.

The invention also discloses a method for retrieving the real-time geographic locations of two smartphones, engaged with each other in a phone call, and for communicating the said retrieved location information pertaining to one of the said two smartphones to—and displaying it on—the other of the said two smartphones and vice versa.

The present application claims priority under 35 U.S.C. §119(e) to U.S. Provisional Patent Application Ser. No. 62/239,868 filed on Oct. 10, 2015. The disclosures of the above-referenced U.S. patent application are incorporated herein by reference.

### FIELD OF THE INVENTION

This invention relates to a smartphone application (app) for ascertaining the real-time geographic location of the calling device and the receiving device, during a phone call and displaying the said location information pertaining to the said calling device to the said receiving device and vice versa.

### BACKGROUND OF THE INVENTION

When a person, not well versed in using the currently available navigation or directional assistance technology and not able to communicate in English or the local language, arrives at a new place, he or she would generally find it extremely difficult to make arrangements to get to his or her destination. The best way for the said person would be to call an acquaintance—ideally, one that speaks the language of the said person and knows the place well—and get the requisite guidance. But, for this, the said person would have to correctly ascertain, identify and communicate his or her current location to the said acquaintance. Now, this could prove difficult if the said person cannot speak English or the local language. Ideally, in this scenario, it would be great help if there existed a system wherein the receiver of a call would automatically be communicated the current location of a caller without the caller having to speak it on the phone.

As can be imagined, in many cases it would be ideal if the calling party and the receiving party, involved in a phone call with each other, were both informed automatically of each other's current location during the said phone call. When a caller identification service is enabled on a receiving phone, it is possible to know the phone number from which a caller calls. But, the caller will not be able to know the location of the called or receiving party, automatically in reciprocity. Many wireless network service providers nowadays do provide a service wherein the current locations of one or more members belonging to the same subscription plan, usually a family subscription plan, are informed of the current or last known locations of fellow members automatically based on pre-programmed or pre-set triggers, periodically, or upon a request from one or more of the said members. The biggest limitation of such system is that such a subscription plan is usually limited to five or six members, usually the members of a single family. Further, if one of the members opts to subscribe to a different service provider, he or she would no longer be part of the said subscription plan, and therefore, would no longer be tracked or located.

U.S. Pat. No. 7,085,578 granted to Barclay et al discloses an apparatus and method to provide location information for a calling party to a called party and/or provide a location for called party to a calling party. However, for its implementation, the said “apparatus and method” disclosed by Barclay et al requires that both the calling party and the called party are subscribers to the same wireless network service provider. This requirement severely limits the utility of the invention disclosed by Barclay et al.

The present invention circumvents and overcomes all such limitations since its implementation does not require the calling party and the called party to be subscribers to a same wireless network service provider. In fact, the primary embodiment of the present invention does not obtain the location information of the calling and called parties from a wireless network service provider. Further, any number of smartphone users can make use of the present invention by simply downloading and enabling/activating the application (app) of the present invention.

### SUMMARY OF THE INVENTION

This invention is basically a smartphone application (app). When a phone call is made from a smartphone—which contains the said application installed in it and enabled by the user—to another smartphone, which also contains the said application installed in it and enabled by the user, the said application that is installed in the caller smartphone is notified of the outgoing call event. In response, the said application obtains the real-time geographic location of the caller smartphone through GPS enabled on the caller smartphone. This location information, in the form of latitude-longitude is then communicated, along with a unique identification alphanumerical or unique ID allocated to the caller's phone number, through web service enabled on the caller device to a central server for resolution of the said location information present in the latitude-longitude format into a simpler user-friendly format, like street address. On the receiver's side, when the said application installed on the smartphone of the receiver is notified of the incoming call event, the said application resolves the caller's unique ID and requests the central server for location details of the caller device based on the caller's unique ID, using web service enabled on the receiver device. The location information received from the central server is then displayed along with native incoming call dialog on the screen of the receiver smartphone. The said application installed on the receiver device runs a background thread, acquires the latitude-longitude information of the GPS-enabled receiver smartphone and communicates—using web service enabled on the receiver device—the said location information tagged with the caller's unique ID, to the central server for resolving the location information and notifying the caller smartphone.

The central server receives the receiver smartphone's latitude-longitude information, resolves it into a simpler user-friendly format, like street address, and sends details to caller smartphone by using either push notification or any other methodology provided by respective smartphone Operating System. On the caller smartphone, the receiver smartphone's real-time geographic location information is displayed as a push notification or any other means provided by native smartphone OS.

### BRIEF DESCRIPTION OF THE DRAWINGS

FIG. 1 illustrates the relative locations and interactions of the major components of the system of the invention disclosed herein.

### DESCRIPTION OF THE COMPONENTS

100 Smartphone (User A's or Caller's smartphone)
200 Smartphone (User B's or Receiver's smartphone)
300 Central server (located on the internet)
400 Internet or web service
500 Application (App) disclosed in this invention

### DETAILED DESCRIPTION OF THE PREFERRED EMBODIMENTS

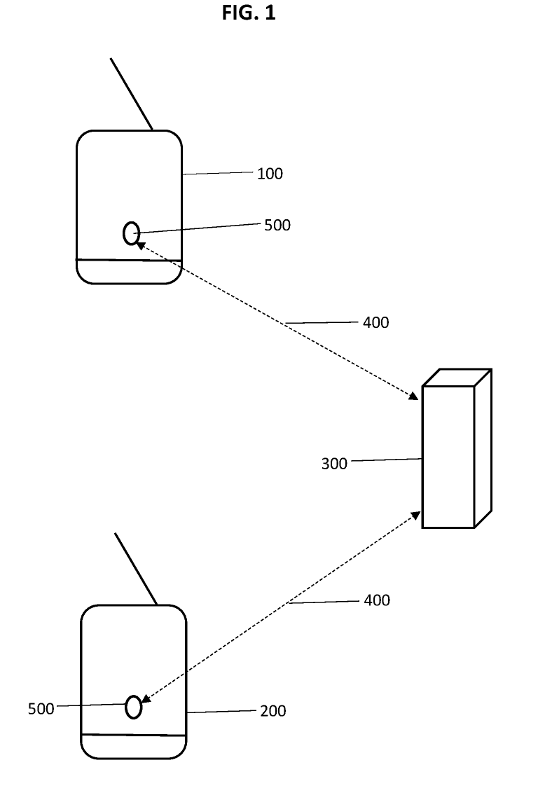

FIG. 1 illustrates the relative locations and interactions of the major components of the system of the invention disclosed herein. This invention discloses a smartphone application (app) 500, which when installed and enabled on two smartphones, can enable retrieval of the real-time geographic locations of both smartphones and further enable communication of the said location information pertaining to one of the said two smartphones to—and it's display on—the other of the said two smartphones and vice versa, wherein both the said smartphones are engaged with each other in a phone call. This invention also discloses a method therefor.

This invention is implementable on smartphones on which applications can be installed; which are enabled with the Global Positioning System (GPS) access, web service or internet access through cellular wireless network service provider's data service (like 3G/4G/LTE) or Wi-Fi; and which have application settings enabled for synchronizing location.

The groundwork for the implementation of the present invention is laid when a smartphone user installs the application 500, disclosed in this invention, on his/her smartphone. For activation of the application 500, the user has to register with his/her phone number (the one associated with his smartphone). An activation code for authentication is sent to the said user's registered phone number. The user needs to authenticate through his smartphone (containing the SIM card pertaining to the user's registered phone number). This step is essential to the implementation of this invention because the phone number associated with the user's smartphone on which the application 500 of this invention is installed, is allocated a unique alphanumerical identification number (unique ID). Thus, the phone numbers associated with all authenticated users of the application 500 of this invention are allocated a unique ID and are represented by it.

A central server 300 situated on the internet (worldwide web), a very important component of the present invention, facilitates the authentication process, provides unique IDs to the registered phone numbers and maintains a repository of unique IDs referenced to their corresponding phone numbers. The central server 300 also maintains a repository of the unique IDs referenced to the last known or real-time location of their corresponding phones. In addition, the most important function of the central server 300 is the resolution of location information present in a latitude-longitude format into a user-friendly format, like the street address. For this purpose, the central server 300 uses one or more geolocation services, like the Google API, Bing API or any provider which provides functionality of Reverse Geo Location (Converting Longitude and Latitude to a simple street address).

For its working, the installed application 500 requires certain permissions at the device level. These include permission to access the GPS components in the smartphone to obtain the latitude-longitude information pertaining to the current location of the smartphone; permission to access the internet (web service) or permission to access the means to access the internet (web service) to enable the internet service (Wi-Fi or cellular network data service); and permission to access the phone contacts listed in the smartphone's phone book and/or call history.

Once installed, authenticated and enabled on a smartphone 100, the application 500 of this invention gets activated when a phone call is made from the said smartphone 100 to another smartphone 200, which also has the said application 500 of this invention installed in it; or when a phone call is received by the said smartphone 100 from the said other smartphone 200. The detailed stepwise description of the working of the present invention, from the time when a phone call is made, is provided hereinafter:
1. User A calls User B
2. From User A (caller)
   1. Native Operating System of the smart phone 100 will notify call-outgoing event to the application 500 installed on smart phone 100.
   2. Application 500 acquires Latitude and Longitude of the phone 100 using the said phone's 100 GPS.
   3. Application 500 communicates caller's unique ID, Latitude & Longitude of the caller to central server 300 using web service 400 from mobile device 100 (need internet access).
3. Central server 300 receives Latitude, Longitude and caller's unique ID. Resolves real time location of Latitude & Longitude using Reverse geolocation services like Google API or similar service.
4. At User B (receiver) end
   1. Native Operating System of the smart phone 200 will notify incoming call event to the application 500 installed on smart phone 200.
   2. Application 500 tries to resolve unique ID of the incoming number based on internal application data stored in phone 200.
   3. Application 500 requests location details of caller based on unique ID from the central server 300.
   4. Application 500 enables display of location details received from the central server 300 along with native incoming call dialog on the screen.
   5. Application 500 runs a background thread and initiates a web service 400 call with receiver Latitude, Longitude and caller unique ID (for notifying).
5. Central server 300 receives Latitude, Longitude and Unique ID (Notify request)
   1. Central server 300 resolves location based on Latitude and Longitude.
   2. Central server 300 sends push notification to the Caller device 100.
6. At User A (caller) end
   1. Location details will be shown as push notification or as dialog box (based on capabilities provided by smartphone 100 native OS) based on the received data (Receiver Location details).
   2. Receiver location details will be shown on screen (Only if Native smart phone 100 Operating System supports, else push notification will be shown. Push notification can be hidden if step 2 is possible).

When a phone call is made from a smartphone 100—which contains the said application 500 of this invention installed on it and enabled by the user—to another smartphone 200, which also contains the said application 500 installed on it and enabled by the user, the said application 500 that is installed on the caller smartphone 100 is notified of the outgoing call event. In response, the said application 500 obtains the real-time geographic location of the caller smartphone 100 through GPS enabled on the caller smartphone 100. This location information, in the form of latitude-longitude is then communicated, along with the caller's unique ID, through web service 400 enabled on the caller device 100 to a central server 300 for resolution of the said location information present in the latitude-longitude format into a simpler user-friendly format, like street address.

On the receiver's side, when the said application 500 installed on the smartphone 200 of the receiver is notified of the incoming call event, the said application 500 resolves the caller's unique ID and requests the central server 300 for location details of the caller device 100 based on the caller's unique ID, using web service 400 enabled on the receiver device 200. The location information received from the central server 300 is then displayed along with native incoming call dialog on the screen of the receiver smartphone 200. The said application 500 installed on the receiver device 200 runs a background thread, acquires the latitude-longitude information of the GPS-enabled receiver smartphone 200 and communicates—using web service 400 enabled on the receiver device 200—the said location information tagged with the caller's unique ID, to the central server 300 for resolving the location information and notifying the caller smartphone 100.

The central server 300 receives the receiver 200 smartphone's latitude-longitude information, resolves it into a simpler user-friendly format, like street address—and sends a push notification to the caller smartphone 100. On the caller smartphone 100, the receiver 200 smartphone's real-time geographic location information is displayed as a push notification or any other way to display details on the mobile screen (this will change based on the capabilities provided by native smartphone OS).

The application of this invention also provides several other optional functionalities and features, some of these include—
1. If native smart phone is not providing any notification during incoming and outgoing calls, application will provide a screen where user need to manually synchronize his/her location to server or location can be synchronized on regular time interval based on settings of the application;
2. Displaying and tracking history of the user location based on settings;
3. Synchronizing phone contacts with server and getting unique ID's based on phone numbers of those contacts who are also using the mobile application disclosed in this invention;
4. Displaying last known location and history (if enabled by user) for the synchronized contacts.

If a user intends not to disclose his/her current geographic location or does not intend to spend on internet services required for the said application to function, he/she may “Turn Off” the option in the said application. As a consequence, the said user will not be able to communicate his/her location or obtain others' location information, during subsequent phone calls.

The foregoing embodiments have also been disclosed in U.S. Provisional Patent Application Ser. No. 62/239,868 filed on Oct. 10, 2015.

In an alternative embodiment, the smartphone application of this invention can ascertain the location of a smartphone it is installed in, based on the location information provided by or obtained from a wireless network or Wi-fi servicing the said smartphone; or through triangulation, based on the location of cell towers involved in servicing the said smartphone.

All the foregoing embodiments illustrate the basic working of the invention. The invention is described in connection with these embodiments, but the invention is not limited to the said embodiments. The scope of the invention is limited only by the claims and the invention encompasses numerous alternatives, modifications and equivalents either mentioned or not mentioned specifically herein. Such alternatives, modifications and equivalents will be apparent to the person(s) skilled in the art.

Numerous specific details are set forth in the foregoing description in order to provide a thorough understanding of the invention. These details are provided for the purpose of example and the invention may be practiced according to the claims without some or all of these specific details.

Acronyms
OS . . . Operating System
ID . . . Identification
GPS . . . Global Positioning System
API . . . Application program interface or Application Programming Interface

I claim:

1. A system for communicating to each of any two mobile phones—subscribed to the said system—during a phone call in which the said two mobile phones are the participants, the instantaneous geographic location information pertaining to the other of the said two mobile phones, the said system comprising:
a) a remotely located computer server accessible through internet, which is programmed to perform the functions of:
(i) facilitating subscription of a plurality of mobile phones to the said system by authenticating and registering mobile phone numbers pertaining to the said mobile phones opting to subscribe to the said system,
(ii) allocating a unique alphanumerical identification number to each mobile phone number subscribed to the said system and storing the said unique alphanumerical identification number referenced to its corresponding mobile phone number in a repository or a database,
(iii) receiving instantaneous geographic location information of each mobile phone subscribed to the said system every time a call is made from or connected to the said subscriber mobile phone,
(iv) storing a list of geographic locations pertaining to each of the said subscriber mobile phones—referenced to the time and date of receipt of said location information and the unique alphanumerical identification number allocated to the mobile phone number corresponding to the said subscriber mobile phone—in a repository or a database,
(v) resolving or converting location information from the latitude-longitude format to a more user-friendly format;
b) a software application installed, activated and enabled on each of the said two mobile phones, which is programmed to perform the steps of:
(i) automatically obtaining—from the location determining software and hardware of the mobile phone on which it is installed—the instantaneous geographic location information pertaining to the mobile phone on which it is installed, when a phone call is made to or received from the other of the said two mobile phones,
(ii) communicating the said geographic location information and the unique alphanumerical identification number allocated to the mobile phone on which it is installed to the said computer server through internet;
wherein, when a phone call is made from one of the said two subscriber mobile phones to the other of the said two subscriber mobile phones,
the said software application installed on the calling mobile phone obtains the instantaneous geographic location information pertaining to the calling mobile phone, and, communicates the said location information and the unique alphanumerical identification number allocated to the calling mobile phone to the said computer server through internet,
the said computer server receives the location information and the unique alphanumerical identification number of the calling mobile phone; resolves the location information from the latitude-longitude format to a more user-friendly format; stores the said location information—in the said repository or database—referenced to the time and date when the said call was made and the unique alphanumerical identification number of the calling mobile phone,
the said software application installed on the receiving mobile phone, when notified of the incoming call from the calling mobile phone by the operating system of the receiving mobile phone, identifies the unique alphanumerical identification number of the calling mobile phone, and, requests the said computer server—through internet—to communicate—through internet—to the receiving mobile phone the latest location information corresponding to the unique alphanumerical identification number of the calling mobile phone,
the said computer server receives the said request of the software application installed on the receiving mobile phone, and, communicates—through internet—to the said software application installed on the receiving mobile phone the latest location information corresponding to the unique alphanumerical identification number of the calling mobile phone,
the said software application installed on the receiving mobile phone, upon receiving the said latest location information corresponding to the calling mobile phone, enables display of the said location information along with native incoming call dialog on the screen of the receiving mobile phone,
the said software application installed on the receiving mobile phone obtains the instantaneous geographic location information pertaining to the receiving mobile phone, and, communicates the said location information and the unique alphanumerical identification number allocated to the receiving mobile phone to the said computer server through internet,
the said computer server receives the location information and the unique alphanumerical identification number of the receiving mobile phone; resolves the location information from the latitude-longitude format to a more user-friendly format; stores the said location information—in the said repository or database—referenced to the time and date when the said call was connected to the receiving mobile phone and the unique alphanumerical identification number of the receiving mobile phone, and
the said computer server communicates to the calling mobile phone the latest location information corresponding to the unique alphanumerical identification number of the receiving mobile phone.

2. A system, according to claim 1, wherein the said software application obtains the instantaneous geographic location information pertaining to the mobile phone on which it is installed, from the software and hardware of the said mobile phone involved in ascertaining the said location information through the global positioning system.

3. A system, according to claims 1 and 2, which is implementable on smartphones capable of accessing internet through cellular wireless network, Wi-Fi or wireless local area network.

4. A system, according to any or any combination of the preceding claims, wherein the said computer server can resolve or convert location information from the latitude-longitude format to the street address format.

5. A system, according to any or any combination of the preceding claims, wherein the said computer server communicates to the calling mobile phone the latest location information corresponding to the unique alphanumerical identification number of the receiving mobile phone, as a push notification.

6. A system, according to any or any combination of the preceding claims, which provides the users of the said subscriber mobile phones means to manually synchronize his/her location to the said computer server or to set or program the said software application to effect automatic location synchronization at regular intervals of time.
